(19) United States
(12) Patent Application Publication
(10) Pub. No.: US 2004/0139169 A1
(43) Pub. Date: Jul. 15, 2004

(54) System and method for real-time web fragment identification and extratcion

(75) Inventors: Gerald Michael O' Brien, Ontario (CA); Douglas Wayne Catton, Ontario (CA); Juan Antonio Guillen, Ontario (CA); Ted Mann, Ottawa (CA); Kathy Snarr, Ottawa (CA)

Correspondence Address: BANNER & WITCOFF, 1001 G STREET N W, SUITE 1100, WASHINGTON, DC, 20001, US

(73) Assignee: CALCAMAR, INC., Ottawa (CA)

(21) Appl. No.: 10/336,004

(22) Filed: Jan. 3, 2003

(51) Int. Cl. G06F 15/16

(52) U.S. Cl. 709/217

(57) ABSTRACT

A system and method for identifying and retrieving portions of a web page from a source web site. The portion of the web page is a web fragment. A web fragment identifier specifies the source web page and navigation instructions for accessing the web page. The web fragment identifier also specifies attributes of the web fragment to enable the system to locate the web fragment. The method includes navigating to and retrieving the source web page and decomposing the source web page into its constituent objects. The system locates the web fragment within decomposed web page based upon the attributes specified in the web fragment identifier. The attributes may include a unique ID name, an absolute position of the fragment within the web page, or a relationship with an anchor point. The anchor point may be located by the system based upon a key phrase specified in the web fragment identifier. The system receives requests for web fragments from remote users and returns the located web fragments to the users for real-time incorporation into a web page.

### FIELD OF THE INVENTION

This invention relates to the identification and extraction of portions of a web page, and in particular, to a system and method for real-time web fragment identification and extraction over a distributed network.

### BACKGROUND OF THE INVENTION

The growth in Internet use is largely attributable to the advent of the World Wide Web. The World Wide Web (WWW) is a service by which a server computer stores web pages that are made available for access by users at remote locations in the network. To view web pages, a user employs a web browser to retrieve a web page and display its contents. The contents can include graphics, text, or other objects. By some counts, the number of web pages available through the WWW numbers in the billions.

The proliferation of web pages is also partly attributable to the ease with which an unsophisticated user can create web pages using any one of a number of web page design products or services. To create a simple web page, a user need not be a sophisticated computer programmer, even though the web pages are typically defined using Hyper Text Markup Language (HTML), eXtensible Markup Language (XML), or a combination of both.

Given the number of web pages, there are many that are directed to the same or similar subject matter. It can be advantageous for a web site to incorporate content from a pre-existing web site. For example, a user may wish to design a web page that includes up-to-date stock market indices data that is already available on a third party web page, such as the specific stock exchange web page.

Currently, one approach to incorporating content from another web page is for a user to “frame” the other page within his or her own web page. One of the disadvantageous of this approach is that the entire contents of the third party web page is incorporated into the user's web page, rather than the desired portion. Often only a portion of the third party page is of interest to the user.

### SUMMARY OF THE INVENTION

The present invention provides a system and methods for identifying web fragments corresponding to portions of a source web site and for relocating and incorporating, in real-time, the web fragments into a destination web site.

In one aspect, the present invention provides a method for obtaining a web fragment, wherein the web fragment is a portion of a source web page. The method operates in conjunction with a system that includes a web fragment identifier defining at least one attribute of the web fragment. The method includes the steps of receiving a request for the web fragment from a requester, navigating to and retrieving the source web page, decomposing the source web page into a set of its constituent objects, selecting the web fragment from the set of constituent objects based upon the web fragment identifier, and returning the selected web fragment to the requester.

In another aspect, the present invention provides a method of identifying and obtaining a web fragment using a remote web fragment extraction system, wherein the web fragment is a portion of a source web page. In this aspect, the method includes the steps of navigating to a source site containing the source web page through the web fragment extraction system, receiving a decomposition of the source web page from the web fragment extraction system, wherein the decomposition includes a set of the web page's constituent objects, selecting the web fragment from the set of constituent objects, identifying at least one attribute from the source web page for locating the selected web fragment, requesting the web fragment from the web fragment extraction system, and receiving the web fragment from the web fragment extraction system.

In another aspect, the present invention provides a system for obtaining a web fragment, wherein the web fragment is a portion of a source web page. The system is coupled to a network and the source web page is located at a source site connected to the network. In this aspect, the system includes a web fragment identifier defining at least one attribute of the web fragment, an interface module for receiving a request for the web fragment from a requester and for returning a response to the requester, a retriever module for navigating to and retrieving the source web page from the source site, a decomposition module for decomposing the web page into a set of its constituent objects, and a selection module for selecting the web fragment from the set of constituent objects based upon the web fragment identifier, wherein the response returned to the requestor is the selected web fragment.

In yet another aspect, the present invention provides a computer program product that includes a computer readable storage medium having code means encoded thereon for performing any of the steps of the above-described methods.

Other aspects and features of the present invention will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings which show an embodiment of the present invention, and in which:

FIG. 1 shows, in block diagram form, a system for web fragment identification and extraction according to the present invention;

FIG. 2 shows a method for web fragment identification and selection, according to the present invention;

FIG. 3 shows further steps in the method for web fragment identification and selection;

FIG. 4(a) shows example content from a sample web page;

FIG. 4(b) shows a web fragment from the content shown in FIG. 4(a);

FIG. 5 shows the HTML code for creating the content shown in FIG. 4(a);

FIG. 6 shows a Web Fragment Collection based upon the content shown in FIG. 4(a); and

FIG. 7 shows a method of web fragment object execution and web fragment retrieval, according to the present invention.

### DESCRIPTION OF SPECIFIC EMBODIMENTS

A. System Architecture

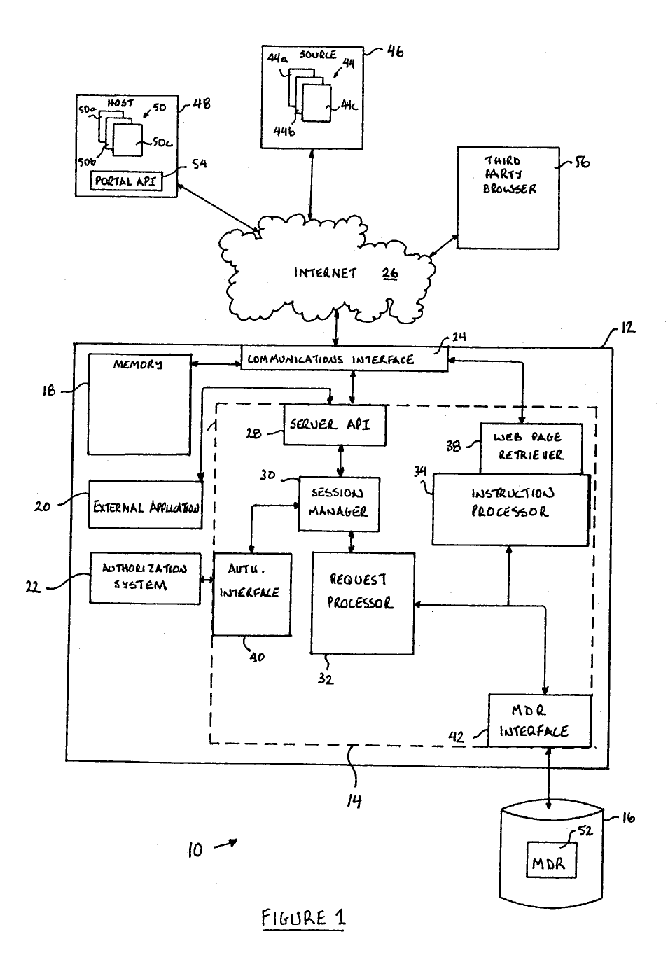

Reference is first made to FIG. 1, which shows, in block diagram form, a system 10 for web fragment identification and extraction according to the present invention. The system 10 is implemented on a world-wide web enabled server 12 and it includes a set of program modules 14 and a storage medium 16.

In addition to the program modules 14, the server 12 may include memory 18 and external applications 20 or modules. One of the external applications 20 or modules may be an authorization system 22.

The server 12 also includes a communications interface 24 to enable the server 12 to communicate with other computers through a network 26, such as the Internet.

The system 10 enables a requestor to request a web fragment from a source web page 44. The source web page 44 is located at a remote source site 46 connected to the network 26. It will be understood that the source site 46 may be physically located anywhere, including within on the same premises as the server 12. The source site 46 may include multiple web pages 44a, 44b, 44c, etc., one of which includes the desired web fragment sought by the requester.

The requester may be local at the server 12 or may be at a remote host site 48 connected to the network 26. The request for a web fragment is typically generated by a web page 50, developed by the requester, which seeks to incorporate the web fragment into its content. The requesting web page 50 may be one of many web pages 50a, 50b, 50c, etc., at the remote host site 48 or in memory 18 on the server 12. In order to incorporate the desired web fragment into its content, the requesting web page 50 issues a request for the web fragment which is communicated to the system 10 through a portal application programming interface (API) 54.

The system 10 receives the request and, if the request is validated, then it retrieves the source web page 44 containing the desired web fragment from the source site 46. Once the program modules 14 receive the source web page 44, the source web page 44 is decomposed into a set of objects, one of which is the desired web fragment. The program modules 14 then extract the object corresponding to the desired web fragment from the set of objects and return it to the requestor.

In order to find the source site 46 and the desired web fragment, the system 10 maintains a metadata repository 52 on the storage medium. The metadata depository 52 contains a plurality of web fragment objects (WFO). Each WFO contains at least one web fragment identifier (WFI) that specifies certain attributes that can be used for locating a web fragment. A WFO may contain multiple WFIs. The WFO also contains navigation information for locating the source site 46 and the source web page 44 containing the desired fragment.

The program modules 14 of the system 10 include a server application programming interface (API) 28 to enable the program modules 14 to communicate with the external applications 20 or with the communications interface 24. The server API 28 receives requests for access to the system 10 from the portal API 54 and communicates results from the program modules 14 back to the portal API 54. Other interfaces included in the program modules 14 include an authorization interface 40 for interacting with the authorization system 22 and an MDR interface 42 for communicating with the metadata repository 52 on the storage medium 16. Although these interfaces 38, 40, 42 are depicted as separate interfaces, it will be understood by one of ordinary skill in the art that they could be implemented as a single multi-purpose interface, or any other combination or subcombination of interfaces.

Also included in the program modules 14 are a session manager 30, a request processor 32, an instruction processor 34, and a web page retriever 38. The session manager 30 receives requests from the server API 28 and enforces requestor authorization. Initial requests include a requestor authorization procedure whereby the session manager 30 verifies that the requestor is entitled to access the system 10. The session manager 30 queries the authorization system 22 through the authorization interface 40 and receives confirmation if the requester is authorized. If authorization is successful, then the session manager 30 assigns a unique session ID to the requestor that is valid until the requestor terminates the session or the requestor has been inactive for a period of time greater than the time allowed.

Subsequent requests by the requester to the system 10 may be requests for access to a particular WFO stored on the storage medium 16. Each WFO may have header information, which includes a set of permissions that identifies the requestors that are entitled to access the WFO, or which may indicate that any requester may have access to the WFO. The session manager 30 will retrieve the requested WFO from the metadata repository 54 through the request processor 32 and the MDR interface 42. The session manager 30 checks the header information to determine whether the active requestor is entitled to have access to the WFO based upon its associated permissions. If the permissions indicate that the requestor is allowed to access the requested WFO, then the session manager 30 instructs the request processor 32 to process the request.

The request processor 32 extracts the information and instructions contained in the desired WFO and organizes the instructions for execution based upon the request. For example, the desired WFO may contain more than one WFI, in which case the request processor 32 will extract the appropriate WFI for the desired web fragment based upon the request received. The instructions are then passed from the request processor 32 to the instruction processor 34 for execution.

The instruction processor 34 executes each instruction sequentially. Among the first of the instructions received will be a navigation instruction that provides the information necessary to locate the source web page 44 and the source site 46 where the desired web fragment can be found. The instruction processor 34 will cause the web page retriever 38 to locate and retrieve the web page 44 based upon the information in the navigate instruction. The retrieved web page 44 may then be stored in a storage register (not shown) on the system 10 for further manipulation or processing.

The instruction processor 34 will then decompose the retrieved web page into a set of its constituent objects based upon an object type directory (not shown) maintained on the system 10. Other instructions that the instruction processor 34 will execute are for the purpose of retrieving an object from the set of objects based upon WFI information. The decomposition of the retrieved web page 44 and the retrieval of objects based upon WFI information will be described in greater detail below.

Once the instruction processor 34 has successfully retrieved the desired web fragment from the decomposed web page, or has failed to locate the desired web fragment, the result is passed back to the request processor 32. The request processor 32, in turn, passes the result to the session manager 30, which then determines which requestor is to receive the results. The results are then communicated to the requestor through the server API 28.

In operation, the system 10 allows a requester to develop web pages 50a, 50b, 50c, etc., that incorporate web fragments from other web pages located on remote sites throughout the network 26. Accordingly, when a third party 56 with access to the network 26 accesses the requestor's web pages 50a, 50b, 50c, etc., the third party 56 is provided with content that transparently incorporates web fragments from the source site(s) 46. The third party 56 need not be aware that the web pages 50a, 50b, 50c, etc., employ the system 10 to retrieve web fragments from other sites on the network 26.

It will be understood by those of ordinary skill in the art that the system 10 may include various input and/or output devices (not shown), including displays, keyboards, mice, etc., whether at the server 12 or at a remote location.

B. Identification of Web Fragments and Construction of WFOs

As outlined above, the metadata repository 52 contains a plurality of WFOs. Each WFO contains at least one WFI that specifies certain attributes that can be used for locating a web fragment. A WFO may contain multiple WFIs for retrieving multiple web fragments. Each WFO also contains navigation information for locating the source site 46.

Users of the system 10 may create WFOs for storage in the metadata repository 52 corresponding to desired web fragments. The process of creating a WFO starts with the user locating the appropriate source web page 44. The system 10 then retrieves and decomposes the source web page 44 into its constituent objects and it allows the user to select the desired web fragment from the collection of objects. This selection of the desired web fragment can be coupled with the selection by the user of particular attributes of the web fragment, which are then combined with attributes identified by the system 10 to generate an appropriate WFI for the web fragment. This WFI is then incorporated into a WFO for storage in the metadata repository 52.

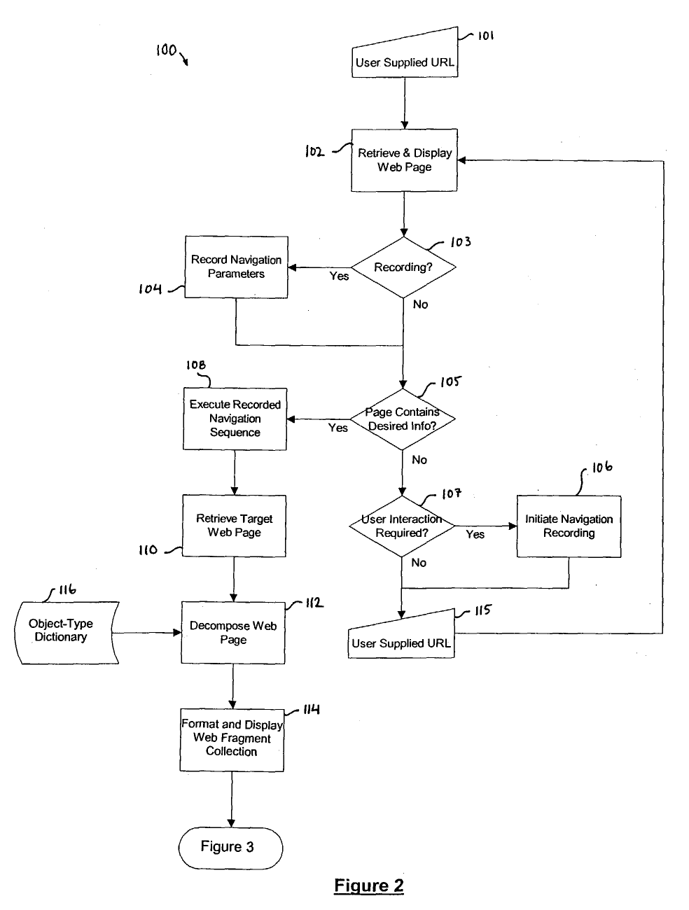

Reference is now made to FIG. 2, which shows a method 100 for web fragment identification and selection, according to the present invention.

The identification method 100 begins, in step 101, with the receipt by the system 10 of a user supplied uniform resource locator (URL). In response to the user supplied URL at step 102 the system 10 retrieves and displays the web page 44 (FIG. 1) identified by the URL for the user in a similar manner to a conventional web browser. The retrieval of the web page 44 is performed by the web page retriever 38 (FIG. 1).

At step 103, if the system 10 is in the process of recording the navigation steps (as is explained further below), then it proceeds to step 104, wherein it records the step taken to arrive at this URL. If the system 10 is not in the process of recording, as would be the case if this is the first URL supplied by the user from step 101, then the method 100 continues directly to step 105.

At step 105, the user indicates whether this is the web page 44 containing the desired web fragment. If not, then in step 107 the system 10 evaluates whether user interaction with the web page 44 is occurring. If the user is interacting with the web page 44 by, for example, supplying login and password information, then the invention initiates a recording in step 106 to capture the navigation information. This recorded navigation information may be necessary for the system 10 to automatically re-navigate to the desired web page 44 when retrieving a web fragment.

If the user is not interacting with the web page 44, or if the recording has been initiated in step 106, then in step 115 a further URL is supplied. This URL may be provided by the user, directly or through selecting a link on the displayed web page 44, or it may result from the user interaction with the web site, i.e. the web page 44 may automatically forward the user to another URL following receipt of the user's login information. The method 100 then returns to step 102 to retrieve and display the web page 44 corresponding to the new URL.

If, in step 105, the user indicates that the displayed web page 44 contains the desired web fragment, then the system 10 attempts to re-navigate to the selected web page 44 in step 108 to confirm it has the ability to reach it. If the web page 44 was arrived at directly, without requiring user interaction, then the system 10 simply retrieves the web page 44 based upon its URL. If user interaction was required such that a navigation recording was made, then in step 108 the system 10 attempts to reach the web page 44 by repeating the recorded navigation sequence.

At this time, any unnecessary URLs are removed from the recorded navigation sequence. The retrieved web page 44 is also parsed for references to other web pages that need to be retrieved at the same time to produce the total content normally seen by a browser of that web page 44. Any such web pages are retrieved and their content is inserted at the point of reference. If the system 10 is unable to retrieve the correct web page 44 based upon the recording, then the user will need to attempt to record the correct navigation steps again.

Once the system 10 has successfully navigated to the desired web page 44, then in step 112 a decomposition module within the system 10 decomposes the web page 44. The decomposition step 112 is based upon a set of predefined object types contained in the object type dictionary 116. The web page 44 is parsed and when fragments (objects) of the parsed web page 44 are found to match an object type defined in the object type dictionary 116, then that fragment is extracted and added to a Web Fragment Collection. Objects may exist within other objects on the web pages, meaning that the Web Fragment Collection may take on a tree-and-branch structure. For example, the web page 44 may include an image within a table structure.

Once the entire web page 44 has been parsed, then in step 114 the Web Fragment Collection is formatted and displayed to the user.

In one embodiment, the system 10 and method 100 may be used to locate and decompose web pages written in the HTML programming language. In this context, the object type dictionary 116 may include objects based upon, and identified by, standard HTML tags and flags. Such objects may include tables, rows, columns, frames, applets, images, and many other objects, as will be understood by those of ordinary skill in the art. These objects can be recognized by the tags or flags used to specify the object in the HTML code for the web page. Accordingly, in one embodiment, when decomposing a web page the system 10 parses the web page based upon the HTML tags or flags in the web page, wherein relevant HTML tags or flags are defined by the object data dictionary 116.

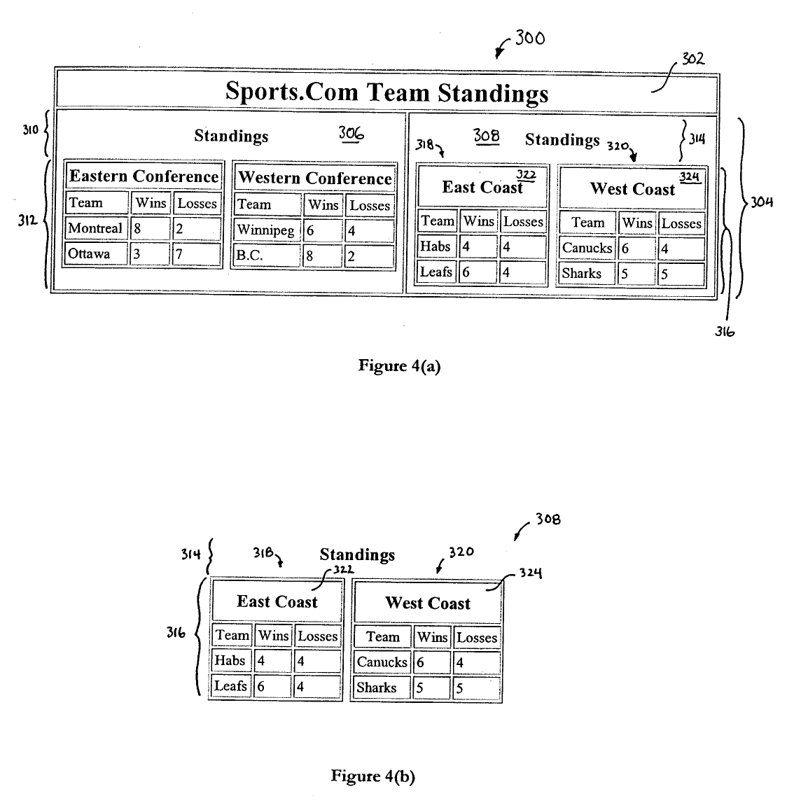

To illustrate the method 100, reference is now made to FIGS. 4(a), 4(b), 5 and 6. By way of example, a web page may include a main table 300 shown in FIG. 4(a). The main table 300 includes a first row 302 and a second row 304. The first row 302 contains the text for the title of the main table 300, “Sports.com Team Standings”. The second row 304 contains two tables: a left table 306 relating to football standings and a right table 308 relating to hockey standings. Like the main table 300, the left table 306 contains an upper row 310 and a lower row 312. Similarly, the right table 308 contains an upper row 314 and a lower row 316. The upper rows 314 both contain the text, “Standings”. Each of the two lower rows 312, 316 contain two tables. The right table 308 lower row 316 contains a first hockey table 318 and a second hockey table 320. The first hockey table 318 contains four rows, including an upper title row 322. Similarly, the second hockey table 320 contains four rows, including an upper title row 324. The upper title row 322 of the first hockey table 318 contains the text, “East Coast” and the upper title row 324 of the second hockey table 320 contains the text, “West Coast”.

The web fragment that a user may wish to incorporate into a separate web page may be solely the right table 308 relating to hockey standings, as shown in FIG. 4(b).

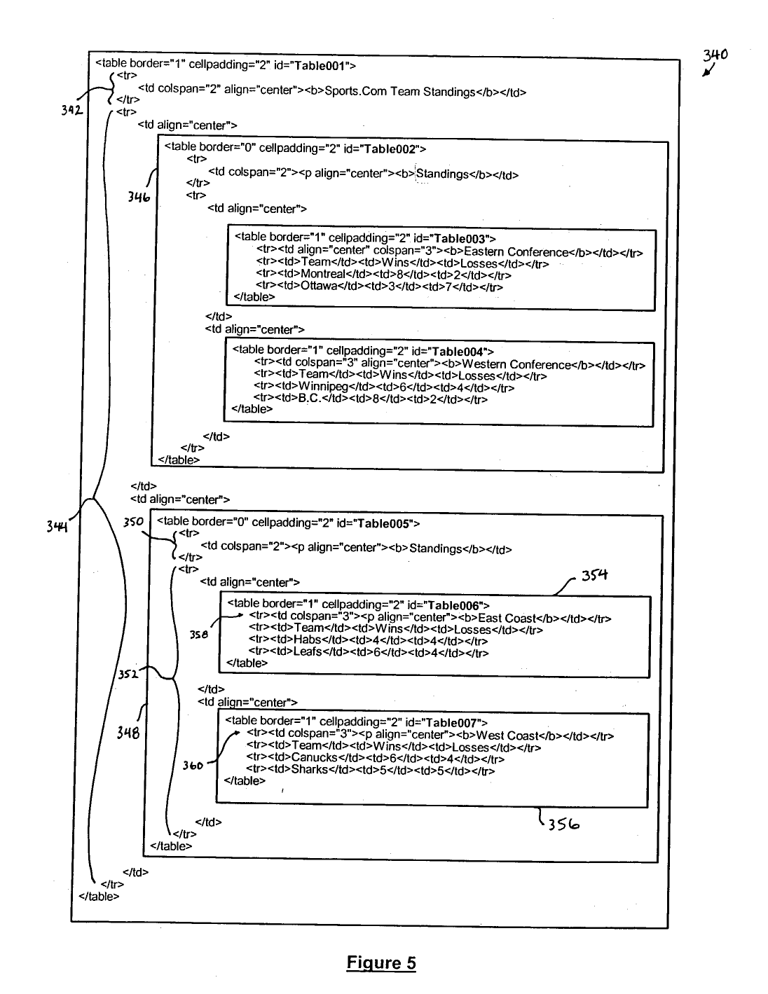

The HTML code 340 for creating the main table 300 is shown in FIG. 5. As will be understood by those skilled in the art, the HTML code 340 includes a first section of code 342 that creates the first row 302 of the main table 300 and a second section of code 344 that creates the second row 304 of the main table 300. Within the second section of code 344 is a first subsection 346 for creating the left table 306 and a second subsection 348 for creating the right table 308. This second subsection 348 of code is the code required to create the desired web fragment, as shown in FIG. 4(b).

Within the second subsection 348 of code is a first portion 350 creating the upper row 314 and a second portion 352 creating the lower row 316. Within the second portion 352 is a first sub-portion 354 for creating the first hockey table 318 and a second sub-portion 356 for creating the second hockey table 320. Each of the sub-portions 354, 356 includes a TABLE tag and four row definitions. The upper title row 322 for the first hockey table 318 is created by TR tag 358. Similarly the upper title row 324 for the second hockey table 320 is created by TR tag 360.

The method 100 described above in conjunction with FIG. 2 would retrieve the HTML code 340 for the table 300 and would decompose the HTML code 340 based upon its tags into its component objects.

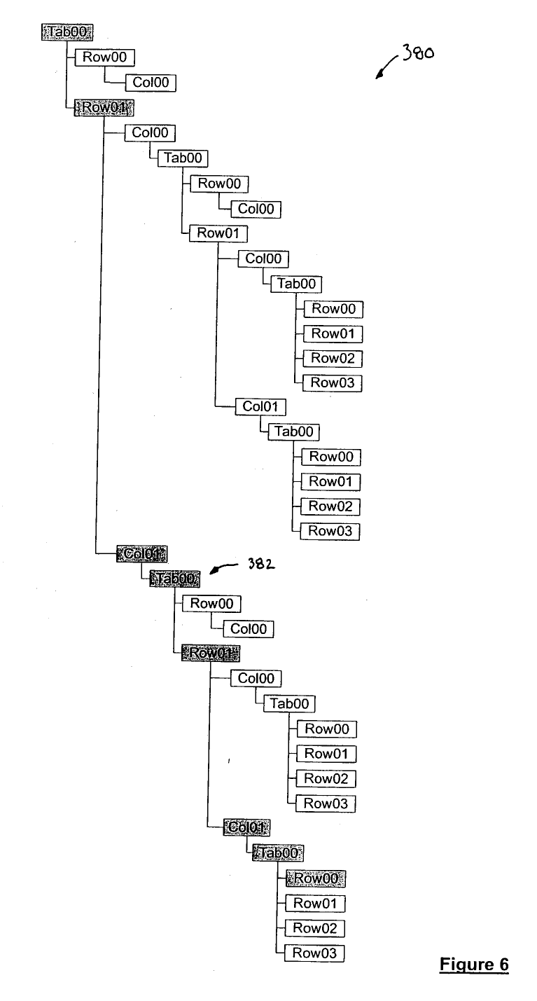

FIG. 6 shows, by way of example, the results of the decomposition of the web page created by the HTML code 340. FIG. 6 shows a Web Fragment Collection (WFC) 380 for the decomposed HTML code 340. Note that the WFC 380 is structured in a tree-and-branch architecture, where each web fragment is given a label. Web fragments that are contained within other web fragments, such as rows within a table, are shown branching form the parent web fragment.

The main table 300 is represented by the leftmost label Tab00. It is shown to contain the first row 302 and the second row 304 by the labels Row00 and Row01, respectively. The desired web fragment, i.e. the right table 308, is shown by Tab00-Row01-Col01-Tab00, as indicated by reference numeral 382.

When the WFC 380 is formatted and displayed to the user in step 114 of the method 100, it may be displayed in the tree-and-branch format shown in FIG. 6. A user may then be permitted to select, using a mouse or other input device, a web fragment from the WFC 380 by selecting one of the labels. For example, in order to select the right table 308, the user selects the corresponding label 382.

The display may be divided into a window for showing the WFC 380 and a window for previewing the selected web fragment from the WFC 380. Accordingly, as a user selects a label, the web fragment corresponding to the selected label is materialized in the preview window so the user can confirm that the appropriate fragment has been selected.

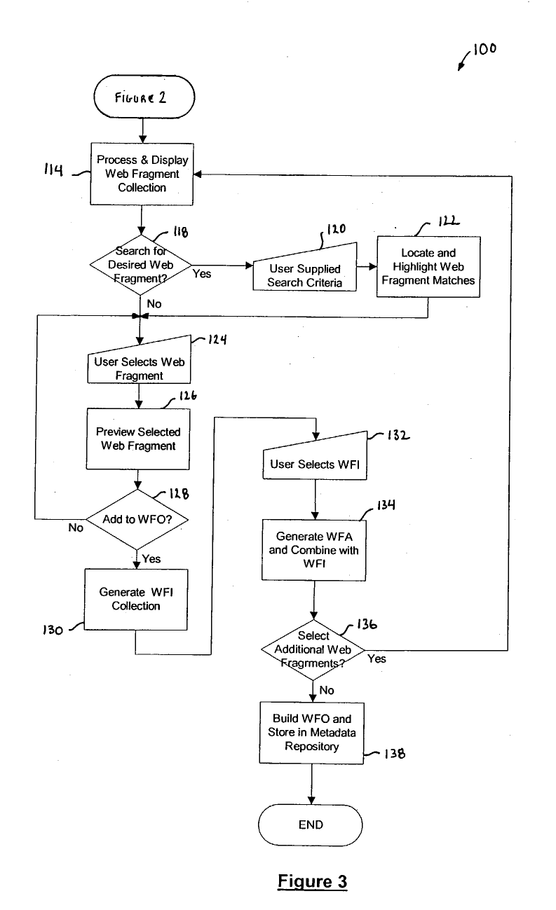

Reference is now made to FIG. 3, which shows further steps in the method 100. As described above, the WFC 380 created in accordance with the method 100 is displayed to the user in step 114.

Following step 114, at step 118 the user is given the option of searching the WFC 380. If the user elects to use the search function, then at step 120 the user supplies search criteria. The system 10 then searches the WFC 380 based upon the search criteria and in step 122 it highlights any resulting web fragment matches located in the search.

Whether or not the user performs a search, the user then selects a web fragment from the displayed WFC 380 in step 124. In step 126, the system displays the selected web fragment, such as in a preview window pane. The user may then evaluate whether the desired web fragment has been located. In step 128, the user elects whether to add the selected web fragment to a WFO. If the user has not found the desired web fragment, then the user will decline to add the selected web fragment to the WFO and the method 100 returns to step 124 to permit the user to select another web fragment. The method 100 may alternatively return to step 118 to allow for further searching.

If the selected web fragment is the one desired by the user, then the user chooses to add the fragment to the WFO. In step 130, the system 10 analyzes the selected web fragment and attempts to generate a list of unique identifiers that may be associated with the web fragment. An example of an identifier is textual matter that is particular to the web fragment. Other examples may include the “id=” unique identifier tag associated with a particular object in the HTML code, the colour attribute of a particular object, or a specific URL that is reference by an object. Identifiers may include material that is at a higher or lower level than the desired web fragment.

By way of example, and with reference to FIGS. 4, 5 and 6, the desired web fragment may be the right table 308. When the user selects this web fragment, then in step 130 (FIG. 3) the system 10 may generate a list of textual descriptors contained within subfragments, such as “Standings”, “East Coast”, “West Coast”, “Teams”, “Wins”, “Losses”, “Habs”, “Leafs”, etc. The system 10 may also generate a list of textual descriptors contained within super-fragments, such as “Sports.com Team Standings”, or within sub-fragments from another branch, such as “Eastern Conference”.

The user may recognize that the text “Standings” is not unique to the right table 308, since that text also appears in the left table 306. Accordingly, this text is not unique enough to serve as an identifier for locating the right table 308. The user may also recognize that the text “West Coast” and “East Coast” is unique to the right table 308. Accordingly, this text may serve as a useful identifier for locating the right table 308 within the whole web page 44.

Reference is again made to FIG. 3. In step 132 the user may select one or more identifiers from the list of potential identifiers provided by the system 10. The system 10 then, in step 134, automatically generates a WFI from the user-selected identifiers, if any, and an automatically generated set of web fragment attributes. Web fragment attributes may include the type of object that has been selected, or the object's location within the hierarchy of the web page 44, i.e. its relation to parent branches. If the selected object has a unique name, as is sometimes the case in HTML or XML programming, then any other attributes may be unnecessary since the object can be retrieved on the basis of its unique ID. This latter situation will result in a fairly simple WFI that references the object its unique ID.

The user-selected identifier in the WFI will include the item selected, such as a text phrase, and its hierarchical relationship to the desired web fragment. This allows the system 10 to later retrieve the web fragment with reference to the user-selected “anchor point”. The system 10 first finds the anchor point based upon the user-selected identifier and then identifies the web fragment based upon the relationship between the identifier and the web fragment, as will be described in greater detail below.

Following step 134, at step 136 the user has the option of selecting other web fragments from the WFC 380. If the user so desires, then the method 100 returns to step 124. If not, then the method 100 continues to step 138, where the system 10 combines any created WFIs into a WFO and stores the WFO in the metadata repository 52.

C. Fragment Identification Language

In one embodiment, the invention includes a Fragment Identification Language (FIL) that structures the format which the system 10 uses to create, read and execute WFOs and WFIs. The instructions provided by the FIL are used to create the WFIs and WFOs. Those instructions are processed by the instruction processor 34 (FIG. 1) when a requestor attempts to retrieve a web fragment using the system 10. The FIL is neutral of any natural or computer programming language and may be employed in connection with implementations of the invention using C, C++, Java or other computer programming languages, or combinations thereof. Accordingly, the system 10 may be used with web pages written in HTML, XML, or any other programming language.

The FIL instructions may be broadly grouped into three types: navigate instructions, retrieve instructions, and resolve instructions. The results of these instructions are assigned to user-defined storage registers. The contents of these registers may be used by subsequent FIL instructions to perform additional operations.

Navigate instructions direct the system 10 to access a specific web page using a predetermined series of steps or actions. Retrieval instructions cause the system 10 to locate and extract specific web fragments from the retrieved page. Resolve instructions cause the system 10 to parse the contents of a storage register for references to other WFOs and, if found, executes them and inserts the results into the contents of the original storage register in place of the reference.

By way of example, a navigate instruction may take the form:

Reg=NAVIGATE (Type, Identifier, Parameters)

In the above instruction, Reg is the name of the register in which the entire contents of the specified web page will be stored. Type specifies the type of Identifier being used, which in the case of a NAVIGATE command with respect to the World Wide Web, would be a URL. The Identifier is the location of the web page that the system 10 is to navigate to, such as “www.cnn.com/index.html”. Parameters specifies any parameters required by the web server computer to deliver the correct page, such as a username or password. The Parameters are optional.

An example of a NAVIGATE instruction is:

PageContents=NAVIGATE (URL, “www.cibc.com/Login.htm”, ?Username=John&Password=abc123)

In this example, the contents of the web page found at “www.cibc.com/Login.htm” using username “John” and password “abc123” would be fetched and placed into the register called “PageContents”.

An example of the form of a retrieve instruction is:

Reg=RETRIEVE (Source, “REF”, TagType, AnchorTag, SubTags, ReturnTag, MatchType, Threshold, Identifier)

As before, Reg is the name of the register in which the results will be stored. Source is the storage register in which the system 10 will find a parsed web page. REF is a literal defining this retrieve instruction as a relative retrieve, i.e. a retrieve operation where the web fragment is identified with reference to its relationship to an anchor point. The alternative is to have an absolute retrieve instruction, which is described below.

TagType is the type of structure that the web fragment constitutes, i.e. an image, a table, etc. Anchor Tag is the type of structure that contains the Identifier(s). SubTags is the number of TagType structures that will be found between the web fragment and the anchor point. This may be a positive number if the web fragment has one or more nested TagType structures within it, inside of which the SubTags structure is found. It may also be a negative number if the SubTags structure is outside of the web fragment structure, and outside one or more nested TagType structures that contain the web fragment. By way of example, the web fragment, and thus the TagType, could be a table and the SubTags may indicate a column. If the web fragment table contains another table, within which the anchor point column is located, then the SubTags would indicate that there is one structure of the type table between the web fragment and the anchor point.

ReturnTags is a Boolean indicator defining whether or not the opening and closing “TagType” tags should be included with the web fragment stored in the Reg storage register. MatchType is a Boolean indicator defining whether the search for the Identifier should be case insensitive or not. Threshold is the percentage of Identifiers that must be present in the AnchorTag structure to constitute a successful anchor point. Finally, Identifier is a keyphrase or set of keyphrases that are unique to the web fragment and define the anchor point within the web page in Source that assists the system 10 in locating the web fragment.

An example of a relative retrieve instruction, based upon our example in connection with FIGS. 4, 5 and 6, is:

HockeyTable=RETRIEVE (WebPage, “REF”, TABLE, TABLE, 0, 0, 1, 100, “East Coast+West Coast”)

The above instruction specifies that the system 10 should seek an object of the type TABLE within the contents of the WebPage storage register, and that it should look for an anchor point that is a TABLE containing both the text “East Coast” and “West Coast”, with a case insensitive match. The instruction also specifies that once the system 10 has located the anchor point, it need move up “0” TABLE objects in the hierarchy to find the desired TABLE web fragment, which it should return without removing the <table> and </table> tags. One hundred percent of the key phrases need to be present for the operation to be successful.

In this example, the smallest TABLE-type web fragment that contains both the text “East Coast” and “West Coast” is the desired right table 308. This is the special case in which the anchor point and the desired web fragment are one and the same.

If the user had selected only one of the textual descriptors as an indicator, such as “West Coast”, then the relative retrieve command may appear as follows:

HockeyTable=RETRIEVE (WebPage, “REF”, TABLE, ROW, 2, 0, 1, 100 “West Coast”)

In this example, the system 10 is told that the anchor point is a ROW containing the key phrase “West Coast” (case insensitive) and it should then backup two (2) TABLE objects in the hierarchy to retrieve the desired TABLE. In this case, the smallest ROW type web fragment containing the text is the upper title row 324 (FIG. 4(a)) within the second hockey table 320 (FIG. 4(a)) within the desired right table 308 (FIG. 4(a)).

A special case of the relative retrieve command is where an object within the HTML code includes an associated unique identifier. In this case, the retrieve command will specify the anchor point based upon the unique identifier of the object. The user need not select any additional keyphrases for the system 10.

If the user did not select an identifier when the WFI was created, or if no appropriate identifiers were available, the RETRIEVE command will have no anchor point to rely upon and must rely upon the absolute position of the web fragment within the web page. This gives rise to the absolute retrieve instruction, which takes the form:

Reg=RETRIEVE (Source, “TAG”, TagName)

In this case, “TAG” is a literal defining the instruction as an absolute retrieve instruction and TagName is the identifier of the absolute position of the web fragment within the web page contained in Source. An example is:

HockeyTable=RETRIEVE (WebPage, “TAG”, “Html00.Tab00.Row01.Col01.Tab00”)

This would retrieve the right table 308 based upon its position in the web page. Of course, if the web page were to change, then the absolute position of the right table 308 may be affected and the absolute retrieve command will fail. It is the ability to link the relative retrieve instruction to unique but invariant text that enhances the usefulness of the relative retrieve command when compared to the absolute instruction.

D. WFO Request Processing

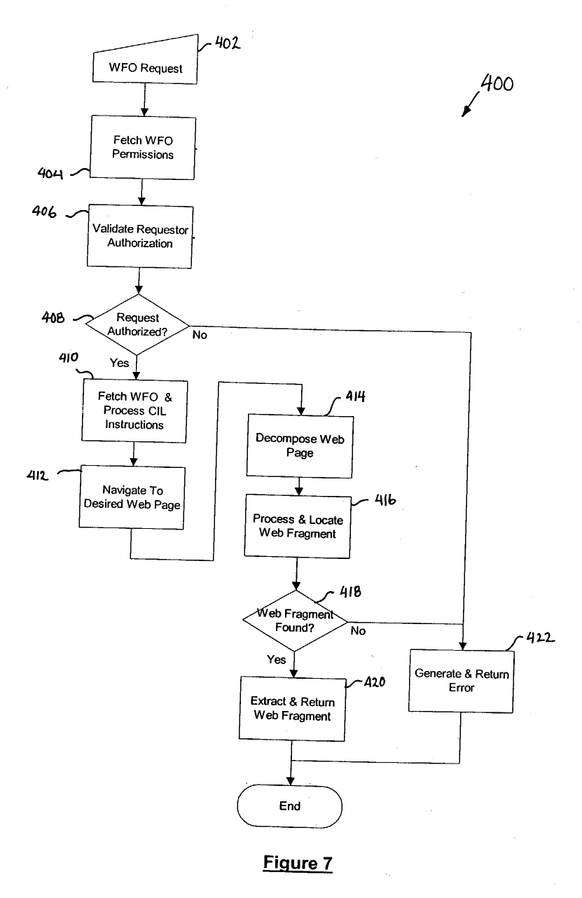

Together with FIG. 1, reference is now made to FIG. 7, which shows a method 400 for web fragment object execution and web fragment retrieval, according to the present invention.

The method 400 begins when the system 10 receives a WFO request from a requester, as shown in step 402. In response, the system 10 retrieves the WFO permissions from the metadata repository 52 in step 404. The permissions are contained within the WFO header and they will specify whether the requestor is entitled to have access to the requested WFO. Then, in step 406, the system 10, in conjunction with any authorization system 22 that may be present, validates the requestor's authorization to access the system 10 and utilize the requested WFO. The authorization step 406 may include obtaining requestor credentials, such as a username or password.

In step 408, the authorization is assessed. If the requestor is the owner of the WFO or the requester is a member of the group access permissions specified in the WFO, then authorization passes and the method 400 continues at step 410. If authorization fails, then the method 400 moves to step 422 where an error message is generated and returned to the requester.

At step 410, the system 10 retrieves the requested WFO from metadata repository 52 and the FIL instructions within the WFO are prepared for execution by the instruction processor 34. The preparation includes verifying the required input parameters, if any. The first instructions processed, at step 412, are the navigate instructions. In response to the navigate instructions the web page retriever 38 accesses the specified web page using any specified navigation steps to interact with the source site 46. The results are stored in a storage register.

The system 10 then, in step 414, decomposes the contents storage register by parsing it using the pre-defined objects from the object type dictionary. As a first part of step 414, the contents of the storage register are parsed for any references to other web pages that need to be retrieved and inserted in place of the references. If any are found, the referenced web page is retrieved and so inserted. Accordingly, the contents of the storage register represent the total content that would be seen by a user viewing the source web page 44. The remainder of step 414 constitutes the parsing of the contents and the building of a Web Fragment Collection by a decomposition module, as was described above in connection with the method 100 shown in FIGS. 2 and 3.

Following the decomposition of the web page, in step 416 the system 10 locates the desired web fragment based upon retrieve FIL instructions. Each retrieve instruction, if more than one, is executed in sequential order. If the retrieve instruction is in the absolute form, then the fragment is identified in the Web Fragment Collection based upon its absolute position in the Collection.

If the retrieve instruction is of the relative form, then the system 10 attempts to locate the anchor point using the identifier specified in the retrieve instruction. It will select as an anchor point the smallest structure of the type specified in the instruction that contains all the key phrases. This structure becomes the anchor point. In the above-described examples with respect to the right table 308 (FIG. 4(a)), the first example was a table structure containing both “East Coast” and “West Coast”, and the second example was a row structure containing “West Coast”. If the system 10 cannot locate a structure containing all the key phrases it may select the smallest structure containing the maximum number of key phrases. There may be a threshold number of key phrases that the system must locate to succeed in identifying an anchor point.

Once the system 10 has located the anchor point, then it identifies the web fragment based upon its specified relation to the anchor point. In our first example regarding the right table 308, the web fragment was identical to the anchor point. In our second example, the web fragment was a table structure containing a table structure that contained the anchor point row.

In step 416, the system 10 assesses whether it has succeeded in identifying the web fragment. The system 10 may fail to find the web fragment in the case of an absolute retrieve instruction if the absolute pointer to the web fragment cannot be located in the Web Fragment Collection. In the case of a relative retrieve instruction, the system 10 may fail if it cannot locate the anchor point, i.e. a structure containing the key phrase or a structure containing a number of key phrases exceeding the threshold. It may also fail if it finds the anchor point but cannot locate the web fragment structure based on its hierarchical relationship to the anchor point.

If, for any of these reasons, the system 10 has failed to locate the web fragment, then at step 422 an error message is generated and returned to the requestor.

If the system 10 has successfully identified the web fragment, then in step 420 the web fragment is extracted from the contents of the storage register and is returned to the requestor.

Although some of the above-described embodiments of the invention have been implemented using the described Fragment Instruction Language, it will be understood by those of ordinary skill in the art that the scope of the invention is not limited to the use of this language and that the invention may be implemented using any other computer programming language or combination of computer programming languages.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A method for obtaining a web fragment, wherein the web fragment is a portion of a source web page, in conjunction with a system including a web fragment identifier defining at least one attribute of the web fragment, the method comprising the steps of:
(a) receiving a request for the web fragment from a requestor;
(b) navigating to and retrieving the source web page;
(c) decomposing the source web page into a set of its constituent objects;
(d) selecting the web fragment from said set of constituent objects based upon the web fragment identifier; and
(e) returning said selected web fragment to said requester.

2. The method claimed in claim 1, wherein the at least one attribute includes an object identifier and the step of selecting includes selecting an object from said set of constituent objects based upon said object identifier, said selected object being said selected web fragment.

3. The method claimed in claim 2, wherein said object identifier includes a unique object name.

4. The method claimed in claim 2, wherein said object identifier includes an absolute position of said selected object within the hierarchy of said set of constituent objects.

5. The method claimed in claim 2, wherein said object identifier includes an object type.

6. The method claimed in claim 5, wherein the at least one attribute further includes an anchor point and a relation between said anchor point and the web fragment.

7. The method claimed in claim 6, wherein said step of selecting includes locating said anchor point within said set of constituent objects and identifying the web fragment within said set of constituent objects in response to said relation between said anchor point and the web fragment.

8. The method claimed in claim 7, wherein said web fragment identifier further includes at least one key phrase and said anchor point includes an anchor object, said anchor object being the smallest object of a specified type within said set of constituent objects containing said at least one key phrase.

9. The method claimed in claim 8, wherein said set of constituent objects includes a plurality of object levels and wherein said relation includes the number of levels between said anchor point and the web fragment.

10. The method claimed in claim 1, wherein said step of decomposing includes parsing the source web page into said set of its constituent objects based upon an object type dictionary.

11. The method claimed in claim 10, wherein said object type dictionary includes objects defined by markup language tags.

12. The method claimed in claim 10, wherein said set of constituent objects includes objects within other objects and is organized in a hierarchical structure.

13. The method claimed in claim 1, wherein said step of navigating includes retrieving the source web page based upon a uniform resource locator, and wherein the uniform resource locator is defined by the web fragment identifier.

14. The method claimed in claim 13, wherein the source web page is located at a source site and said step of navigating further includes interacting with said source site.

15. The method claimed in claim 14, wherein the step of interacting with the source site includes providing login information to gain access to the source web page.

16. The method claimed in claim 1, further including a first step of creating the web fragment identifier in response to input from a user.

17. The method claimed in claim 16, wherein said step of creating includes accessing the source web page.

18. The method claimed in claim 17, wherein said step of creating further includes recording the process of accessing the source web page.

19. The method claimed in claim 16, wherein said step of creating includes receiving an input identifying the web fragment from the user.

20. The method claimed in claim 19, wherein said step of creating further includes receiving an input identifying the at least one attribute.

21. The method claimed in claim 20, wherein the at least one attribute includes a user-selected anchor point.

22. A system for obtaining a web fragment, wherein the web fragment is a portion of a source web page, the system being coupled to a network, the source web page being located at a source site connected to the network, the system comprising:
(a) a web fragment identifier defining at least one attribute of the web fragment;
(b) an interface module for receiving a request for the web fragment from a requestor and for returning a response to the requestor;
(c) a retriever module for navigating to and retrieving the source web page from the source site;
(d) a decomposition module for decomposing the web page into a set of its constituent objects; and
(e) a selection module for selecting the web fragment from said set of constituent objects based upon the web fragment identifier, wherein said response is said selected web fragment.

23. The system claimed in claim 22, wherein said at least one attribute includes an object identifier and said selection module selects an object from said set of constituent objects based upon said object identifier, said selected object being said selected web fragment.

24. The system claimed in claim 23, wherein said object identifier includes a unique object name.

25. The system claimed in claim 23, wherein said object identifier includes an absolute position of said selected object within the hierarchy of said set of constituent objects.

26. The system claimed in claim 23, wherein said object identifier includes an object type.

27. The system claimed in claim 26, wherein said at least one attribute further includes an anchor point and a relation between said anchor point and the web fragment.

28. The system claimed in claim 27, wherein said selection module a location module for locating said anchor point within said set of constituent objects and an identification module for identifying the web fragment within said set of constituent objects in response to said relation between said anchor point and the web fragment.

29. The system claimed in claim 28, wherein said web fragment identifier further includes at least one key phrase and said anchor point includes an anchor object, said anchor object being the smallest object of a specified type within said set of constituent objects containing said at least one key phrase.

30. The system claimed in claim 29, wherein said set of constituent objects includes a plurality of object levels and wherein said relation includes the number of levels between said anchor point and the web fragment.

31. The system claimed in claim 2, further including an object-type dictionary defining types of objects and wherein said decomposition module includes a parsing module for parsing the source web page into said set of its constituent objects based upon said types of objects.

32. The system claimed in claim 31, wherein said types of objects are defined by markup language tags.

33. The system claimed in claim 31, wherein said set of constituent objects includes objects within other objects and is organized in a hierarchical structure.

34. The system claimed in claim 22, further including a web fragment object containing said web fragment identifier, said web fragment object further including a uniform resource locator corresponding to the source web page, and wherein said retriever module retrieves the source web page based upon said uniform resource locator.

35. The system claimed in claim 34, wherein said retriever module includes an interaction module for interacting with said source site to retrieve the source web page.

36. The system claimed in claim 35, wherein said web fragment object includes login information to gain access to the source web page.

37. The system claimed in claim 22, further including a metadata repository having a plurality of web fragment objects, and wherein at least one of said web fragment objects includes the web fragment identifier.

38. A computer program product for obtaining a web fragment, wherein the web fragment is a portion of a source web page, the computer program product operating in conjunction with a system including a web fragment identifier defining at least one attribute of the web fragment, the computer program product comprising:
a computer readable storage medium, having encoded thereon
(i) code means for receiving a request for the web fragment from a requester;
(ii) code means for navigating to and retrieving the source web page;
(iii) code means for decomposing the source web page into a set of its constituent objects;
(iv) code means for selecting the web fragment from said set of constituent objects based upon the web fragment identifier; and
(v) code means for returning said selected web fragment to said requestor.

39. A method of identifying and obtaining a web fragment using a remote web fragment extraction system, wherein the web fragment is a portion of a source web page, the method including the steps of:
(a) navigating to a source site containing the source web page through the web fragment extraction system;
(b) receiving a decomposition of the source web page from the web fragment extraction system, wherein said decomposition includes a set of the web page's constituent objects;
(c) selecting the web fragment from said set of constituent objects;
(d) identifying at least one attribute from the source web page for locating the selected web fragment;
(e) requesting the web fragment from the web fragment extraction system; and
(f) receiving the web fragment from the web fragment extraction system.
